(19) United States
(12) Patent Application Publication
(10) Pub. No.: US 2025/0284930 A1
(43) Pub. Date: Sep. 11, 2025

(54) SEMANTICS AWARE AUXILIARY REFINEMENT NETWORK

(71) Applicant: QUALCOMM Incorporated, San Diego, CA (US)

(72) Inventors: Risheek GARREPALLI, San Diego, CA (US); Munawar HAYAT, San Diego, CA (US); Fatih Murat PORIKLI, San Diego, CA (US)

(21) Appl. No.: 18/601,849

(22) Filed: Mar. 11, 2024

(51) Int. Cl. G06N 3/045

(52) U.S. Cl. CPC G06N 3/045

(57) ABSTRACT

output, based on the input data, a first set of activations from a first layer of a diffusion network to an auxiliary network. The combine the first set of activations from the first layer of the diffusion network to a first set of activations from a first layer of the auxiliary network to generate first combined activations. The output a second set of activations from a second layer of a diffusion network to the auxiliary network and can combine the second set of activations from the second layer of the diffusion network to the first combined activations to generate second combined activations. The process, at a second layer of the auxiliary network, the second combined activations to generate auxiliary network output activations. The apply the auxiliary network output activations to the diffusion network.

### TECHNICAL FIELD

The present disclosure generally relates to machine learning systems, such as neural networks. For example, aspects of the present disclosure relate to systems and techniques for providing a semantics aware auxiliary refinement network.

### BACKGROUND

Diffusion models show promise for the context of generative modeling in which a user provides text describing a scene and from that text the model generates an image of a video. Step distilled diffusion models that use fewer forward passes through the network have a performance drop. Stable diffusion models are being used for artificial intelligence art generation or video generation and efforts have been made to enable increased stability even when using fewer sampling steps. Diffusion models have some loss in quality in use some cases when fewer steps are used, and need a large amount of computing power which limits their use on mobile devices or edge devices in a network.

### SUMMARY

Systems and techniques are described herein for systems and techniques for providing a semantics aware auxiliary refinement network. For example, an apparatus to provide generative modeling is described. The apparatus includes one or more memories configured to store input data and one or more processors coupled to the one or more memories and configured to: output, based on the input data, a first set of activations from a first layer of a diffusion network to an auxiliary network; combine the first set of activations from the first layer of the diffusion network to a first set of activations from a first layer of the auxiliary network to generate first combined activations; output a second set of activations from a second layer of a diffusion network to the auxiliary network; combine the second set of activations from the second layer of the diffusion network to the first combined activations to generate second combined activations; process, at a second layer of the auxiliary network, the second combined activations to generate auxiliary network output activations; and apply the auxiliary network output activations to the diffusion network.

In another illustrative example, a method of generative modeling is provided. The method includes: outputting, based on input data, a first set of activations from a first layer of a diffusion network to an auxiliary network; combining the first set of activations from the first layer of the diffusion network to a first set of activations from a first layer of the auxiliary network to generate first combined activations; outputting a second set of activations from a second layer of a diffusion network to the auxiliary network; combining the second set of activations from the second layer of the diffusion network to the first combined activations to generate second combined activations; processing, at a second layer of the auxiliary network, the second combined activations to generate auxiliary network output activations; and applying the auxiliary network output activations to the diffusion network.

In another illustrative example, an apparatus to provide generative modeling is described. The apparatus includes: means for outputting, based on input data, a first set of activations from a first layer of a diffusion network to an auxiliary network; means for combining the first set of activations from the first layer of the diffusion network to a first set of activations from a first layer of the auxiliary network to generate first combined activations; means for outputting a second set of activations from a second layer of a diffusion network to the auxiliary network; means for combining the second set of activations from the second layer of the diffusion network to the first combined activations to generate second combined activations; means for processing, at a second layer of the auxiliary network, the second combined activations to generate auxiliary network output activations; and means for applying the auxiliary network output activations to the diffusion network.

In another illustrative example, a non-transitory computer-readable medium is provided having stored thereon instructions that, when executed by one or more processors, cause the one or more processors to: output, based on input data, a first set of activations from a first layer of a diffusion network to an auxiliary network; combine the first set of activations from the first layer of the diffusion network to a first set of activations from a first layer of the auxiliary network to generate first combined activations; output a second set of activations from a second layer of a diffusion network to the auxiliary network; combine the second set of activations from the second layer of the diffusion network to the first combined activations to generate second combined activations; process, at a second layer of the auxiliary network, the second combined activations to generate auxiliary network output activations; and apply the auxiliary network output activations to the diffusion network.

In another illustrative example, an apparatus to providing generative modeling based on input data is described. The apparatus includes one or more memories configured to store the input data and one or more processors coupled to the one or more memories and configured to: apply an auxiliary network to a diffusion network to a portion of a training process or an inference process of the diffusion network; and when the auxiliary network is applied: output, based on the input data, a first set of activations from a first layer of the diffusion network to the auxiliary network; combine the first set of activations from the first layer of the diffusion network to a first set of activations from a first layer of the auxiliary network to generate first combined activations; output a second set of activations from a second layer of a diffusion network to the auxiliary network; combine the second set of activations from the second layer of the diffusion network to the first combined activations to generate second combined activations; and process, at a second layer of the auxiliary network, the second combined activations to generate auxiliary network output activations used for the training process or the inference process of the diffusion network.

In another illustrative example, a method of generative modeling based on input data is provided. The method includes: applying an auxiliary network to a diffusion network to a portion of a training process or an inference process of the diffusion network; and when the auxiliary network is applied: outputting, based on the input data, a first set of activations from a first layer of the diffusion network to the auxiliary network; combining the first set of activations from the first layer of the diffusion network to a first set of activations from a first layer of the auxiliary network to generate first combined activations; outputting a second set of activations from a second layer of a diffusion network to the auxiliary network; combining the second set of activations from the second layer of the diffusion network to the first combined activations to generate second combined activations; and processing, at a second layer of the auxiliary network, the second combined activations to generate auxiliary network output activations used for the training process or the inference process of the diffusion network.

In another illustrative example, an apparatus to provide a generative model based on input data is described. The apparatus includes: means for applying an auxiliary network to a diffusion network to a portion of a training process or an inference process of the diffusion network; and means for, when the auxiliary network is applied: outputting, based on the input data, a first set of activations from a first layer of the diffusion network to the auxiliary network; combining the first set of activations from the first layer of the diffusion network to a first set of activations from a first layer of the auxiliary network to generate first combined activations; outputting a second set of activations from a second layer of a diffusion network to the auxiliary network; combining the second set of activations from the second layer of the diffusion network to the first combined activations to generate second combined activations; and processing, at a second layer of the auxiliary network, the second combined activations to generate auxiliary network output activations used for the training process or the inference process of the diffusion network.

In another illustrative example, a non-transitory computer-readable medium is provided having stored thereon instructions that, when executed by one or more processors, cause the one or more processors to: apply an auxiliary network to a diffusion network to a portion of a training process or an inference process of the diffusion network; and when the auxiliary network is applied: output, based on the input data, a first set of activations from a first layer of the diffusion network to the auxiliary network; combine the first set of activations from the first layer of the diffusion network to a first set of activations from a first layer of the auxiliary network to generate first combined activations; output a second set of activations from a second layer of a diffusion network to the auxiliary network; combine the second set of activations from the second layer of the diffusion network to the first combined activations to generate second combined activations; and process, at a second layer of the auxiliary network, the second combined activations to generate auxiliary network output activations used for the training process or the inference process of the diffusion network.

In some aspects, one or more of apparatuses described herein include a mobile device (e.g., a mobile telephone or so-called “smart phone” or other mobile device), a wireless communication device, a vehicle or a computing device, system, or component of the vehicle or an autonomous driving vehicle, an extended reality device (e.g., a virtual reality (VR) device, an augmented reality (AR) device, an extended reality (XR) or a mixed reality (MR) device), a wearable device, a personal computer, a laptop computer, a server computer, a camera, or other device, devices used for image/video editing and image/video generation and editing. In some aspects, the one or more processors include an image signal processor (ISP). In some aspects, the apparatus includes a camera or multiple cameras for capturing one or more images. In some aspects, the one or more apparatuses include an image sensor that captures the image data. In some aspects, one or more apparatuses include a display for displaying the image, one or more notifications (e.g., associated with processing of the image), and/or other displayable data.

This summary is not intended to identify key or essential features of the claimed subject matter, nor is it intended to be used in isolation to determine the scope of the claimed subject matter. The subject matter should be understood by reference to appropriate portions of the entire specification of this patent, any or all drawings, and each claim.

The foregoing, together with other features and aspects, will become more apparent upon referring to the following specification, claims, and accompanying drawings.

### BRIEF DESCRIPTION OF THE DRAWINGS

Illustrative aspects of the present application are described in detail below with reference to the following figures:

FIG. 1 is a diagram illustrating a forward diffusion process and a reverse diffusion process of a diffusion model, in accordance with some aspects;

FIG. 2 is a diagram illustrating how diffusion data distributes from initial data to noise using a diffusion model, in accordance with some aspects;

FIG. 3 is a diagram illustrating a U-Net architecture for a diffusion model, in accordance with some aspects;

FIG. 4 illustrates a baseline step distillation image with an example of a four-step process and an example of a two-step process, in accordance with some aspects;

FIG. 5 is a diagram illustrating the refinement or auxiliary network for high quality step distillation, in accordance with some aspects;

FIG. 6A is a flow diagram illustrating a process for using an auxiliary network for high quality step distillation, in accordance with some aspects;

FIG. 6B is another flow diagram illustrating a process for using an auxiliary network for high quality step distillation, in accordance with some aspects;

FIG. 7 is a block diagram illustrating an example of a deep learning network, in accordance with some aspects of this disclosure; and

FIG. 8 is a diagram illustrating an example system architecture for implementing certain aspects described herein, in accordance with some aspects of this disclosure.

### DETAILED DESCRIPTION

Certain aspects of this disclosure are provided below. Some of these aspects may be applied independently and some of them may be applied in combination as would be apparent to those of skill in the art. In the following description, for the purposes of explanation, specific details are set forth in order to provide a thorough understanding of aspects of the application. However, it will be apparent that various aspects may be practiced without these specific details. The figures and description are not intended to be restrictive.

The ensuing description provides example aspects only, and is not intended to limit the scope, applicability, or configuration of the disclosure. Rather, the ensuing description of the example aspects will provide those skilled in the art with an enabling description for implementing an example aspect. It should be understood that various changes may be made in the function and arrangement of elements without departing from the scope of the application as set forth in the appended claims.

Machine learning systems (e.g., deep neural network systems or models) can be used to perform a variety of tasks such as, for example and without limitation, generative modeling such as text-to-image generation and text-to-video generation, computer code generation, text generation, speech recognition, natural language processing tasks, detection and/or recognition (e.g., scene or object detection and/or recognition, face detection and/or recognition, speech recognition, etc.), depth estimation, pose estimation, image reconstruction, classification, three-dimensional (3D) modeling, dense regression tasks, data compression and/or decompression, and image processing, among other tasks. Moreover, machine learning models can be versatile and can achieve high quality results in a variety of tasks.

Step-distilled diffusion models are one example of a machine learning system that is used for generative modeling such as text-to-image or text-to-video generation. A downside of such models is their slow sampling time. Generating high quality samples takes many hundreds or thousands of model evaluations. Some contributions to seek to eliminate this downside include a parameterization of the diffusion model to increase stability when using a few sampling steps. See Salimans, Ho, “Progressive Distillation for Fast Sampling of Diffusion Models”, ICLR, 2022, incorporated herein by reference. Training diffusion models as described in the incorporated article still require significant compute power with inherent tradeoffs between training time and quality. To improve the quality of the final generation, some approaches adopt another module or network that is used to try and refine the image or other output. However, such refiner modules usually focus on high-frequency components improve quality but lack knowledge of semantics and are placed in the processing flow serially after the diffusion model or network.

Systems, apparatuses, electronic devices, methods (also referred to as processes), and computer-readable media (collectively referred to herein as “systems and techniques”) are described herein for providing a semantics aware auxiliary refinement network. For example, the systems and techniques can use a step-distilled diffusion model or neural network in which a semantics aware auxiliary network is introduced to process high-frequency components or other types of components of data to improve the quality of the network at training and/or inference. In some cases, the step-distilled diffusion model or network an aggressive step-distillation process that only requires a one or two step forward pass without the significant training needed and that can still maintain good performance.

In some examples, the semantics-aware auxiliary network can focus on the high-frequency or other components of the data to improve the quality of the step-distilled model. For instance, performance reduction when using a step-distilled diffusion model or network is primarily in the low frequency components of the images. The auxiliary network can focus on the high-frequency components where the performance impact is the greatest relative to other components of images processed in the step-distilled diffusion model or network. The systems and techniques can also be used to provide extra computing power consistency or intermittently for any portion of processed data that may require additional computations to maintain good performance. Thus, the principles disclosed herein are not limited to high or low frequency components but can also be applied to other aspects of the data being processed.

The systems and techniques described herein add processing capacity to compensate for the loss of quality for a step-distillation diffusion model. The auxiliary network can be applied in parallel to the step-distillation diffusion model and can provide the additional capacity and can be dropped in as needed based on any number of parameters.

The systems and techniques enable the introduction of a faster and more efficient model that can be deployed on devices (e.g., mobile devices, extended reality (XR) devices, vehicles or devices or systems of vehicles, etc.), including devices with less computing resources or on an edge node of a network. The systems and techniques can operate with any diffusion model, such as diffusion models that relate to image or video generation or processing, to audio domains, among others.

In some aspects, at training time or inference time in diffusion models, use of the auxiliary network provides an improvement in quality when a small number of steps are used to process images or other data such as with a diffusion network. The auxiliary network can be configured to be used in parallel to the diffusion network permanently or may be dropped in or taken out as needed for providing extra compute resources based on any number of factors. For example, during training, the auxiliary network may be applied at the beginning of the training process to improve the high frequency component weight generation for the network and then dropped out after a certain number of passes through the diffusion network.

In some cases, an apparatus to provide generative modeling can be provided. The apparatus can include one or more memories configured to store input data; and one or more processors coupled to the one or more memories and configured to: output, based on the input data, a first set of activations from a first layer of a diffusion network to an auxiliary network; combine the first set of activations from the first layer of the diffusion network to a first set of activations from a first layer of the auxiliary network to generate first combined activations; output a second set of activations from a second layer of a diffusion network to the auxiliary network; combine the second set of activations from the second layer of the diffusion network to the first combined activations to generate second combined activations; process, at a second layer of the auxiliary network, the second combined activations to generate auxiliary network output activations; and apply the auxiliary network output activations to the diffusion network. Applying the auxiliary network can be performed for a training phase or an inference phase in the use of the diffusion network. The auxiliary network may also be used for a portion of a training process or an inference process for extra compute resources for high-frequency components of an image or other data or for any other portion of the data that may need extra processing for positive results.

The systems and techniques described herein can be used for performing generative modeling using machine learning models in some cases. The machine learning models can have a reduced step requirement (e.g., a reduced number of steps when training or processing a diffusion model) and can operate on computing devices with limited resources (e.g., edge devices or nodes within networks) while achieving quality results. For example, the systems and techniques described herein can achieve similar performance to a native cloud-level generative model with an edge-class diffusion model. While examples are described herein using the task of generative modeling, the systems and techniques can apply to any neural network or machine learning model task when the quality of the generated contents can be assessed objectively.

As noted above, one class of machine learning models includes diffusion models (e.g., diffusion-based neural networks), which can also be referred to as diffusion probabilistic models. Diffusion models are latent-variable models. For example, a diffusion model defines a Markov chain of diffusion steps to slowly add random noise (e.g., Gaussian noise) to data and then learn to reverse the diffusion process to construct desired data samples from the noise. For instance, a diffusion model can be trained using a forward diffusion process (which is fixed) and a reverse diffusion process (which is learned). A diffusion model can be trained to be able to perform a generative process (e.g., a denoising process). A goal of a diffusion model is to be able to denoise any arbitrary noise added to input data (e.g., a video).

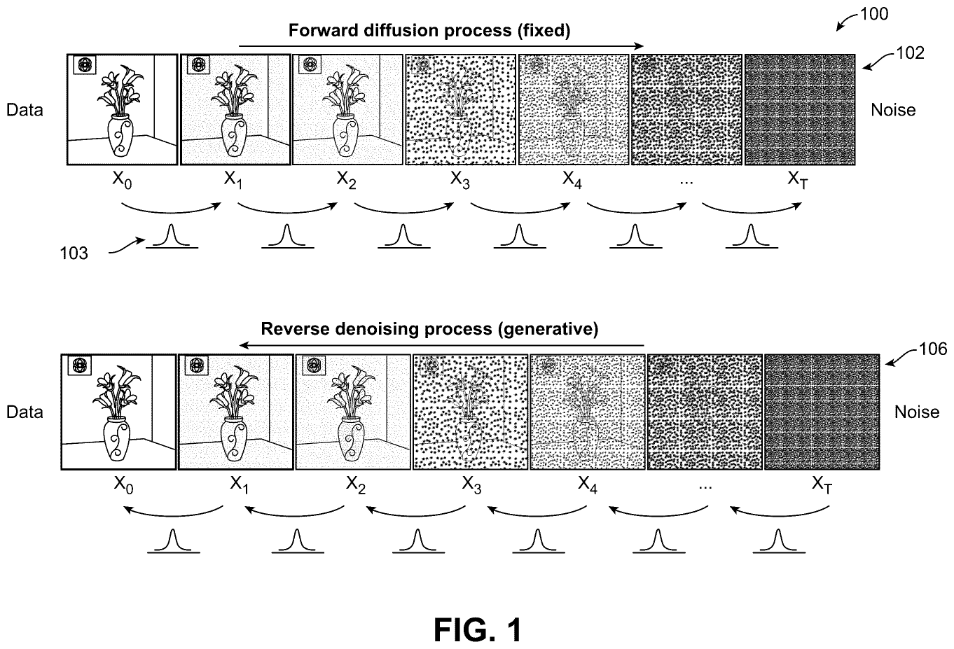

FIG. 1 provides two sets of images 100 that show the forward diffusion process (which is fixed) and the reverse diffusion process (which is learned) of a diffusion model. As shown in the forward diffusion process of FIG. 1, noise 103 is gradually added to a first set of images 102 at different time steps for a total of T time steps (e.g., making up a Markov chain), producing a sequence of noisy samples X₁ through X_{T}.

Diffusion models from a training perspective will take an image and will slowly add noise to the image to destroy the information in the image. In some aspects, the noise 103 is Gaussian noise, although the noise is not limited to any specific type of noise. Each time step can correspond to each consecutive image of the first set of images 102 shown in FIG. 1. The initial image X₀ of FIG. 1 is of a vase. Addition of the noise 103 to each image (corresponding to noisy samples X₁ to X_{T}) results in gradual diffusion of the pixels in each image until the final image (corresponding to sample X_{T}) essentially matches the noise distribution. For example, by adding the noise, each data sample X₁ through X_{T} gradually loses its distinguishable features as the time step becomes larger, eventually resulting in the final sample X_{T} being equivalent to the target noise distribution, for instance a unit variance zero-centered Gaussian [symbol] (0, 1).

The second set of images 104 shows the reverse diffusion process in which X_{T} is the starting point with a noisy image (e.g., one that has Gaussian noise or some other type of noise). The diffusion model can be trained to reverse the diffusion process (e.g., by training a model p_{θ}(xₜ₋₁|xₜ)) to generate new data. In some aspects, a diffusion model can be trained by finding the reverse Markov transitions that maximize the likelihood of the training data. By traversing backwards along the chain of time steps, the diffusion model can generate the new data. For example, as shown in FIG. 1, the reverse diffusion process proceeds to generate X₀ as the image of the vase. In other cases, the input data and output data can vary based on the task for which the diffusion model is trained.

As noted above, the diffusion model is trained to be able to denoise or recover the original image X₀ in an incremental process as shown in the second set of images 304. In some aspects, the neural network of the diffusion model can be trained to recover Xₜ given Xₜ₋₁, such as provided in the below example equation:

$$q ( {x}_{t} \vert {x}_{t - 1} ) = ( {x}_{t} ; \sqrt{1 - {β}_{t}} {x}_{t - 1} , {β}_{t} I )$$

A diffusion kernel can be defined as:

$$Define {∝}_{t} = {\prod }_{s = 1}^{t} ( 1 - {β}_{s} ) \to q ( {x}_{t} \vert {x}_{0} ) = ( {x}_{t} ; \sqrt{{\hat{∝}}_{t}} {x}_{0} , ( 1 - {∝}_{t} ) I )$$

Sampling can be defined as follows:

$${x}_{t} = \sqrt{{∝}_{t}} {x}_{0} + \sqrt{1 - {∝}_{t}} ε where ε ∼ ( 0 , I ) .$$

In some cases, the βₜ values schedule (also referred to as a noise schedule) is designed such that ∝_{T}→0 and q(x_{T}|x₀)≈ [symbol] (x_{T}; 0, I).

The diffusion model runs in an iterative manner to incrementally generate the input image X₀. In one example, the model may have twenty steps. However, in other examples, the number of steps can vary.

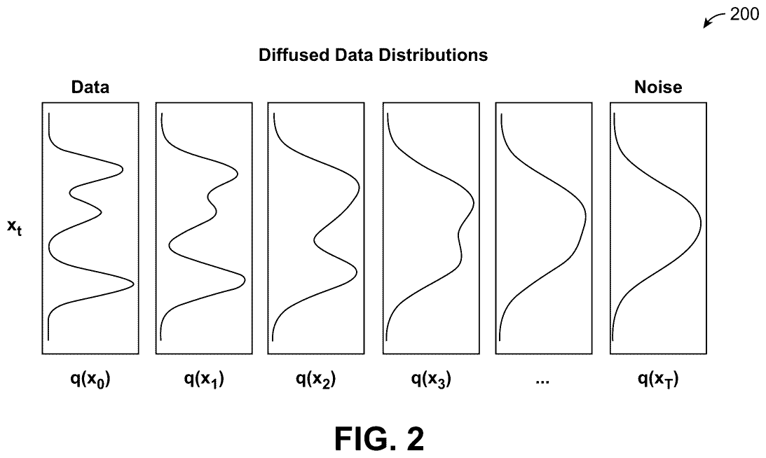

Usually, diffusion models are trained at training and prediction in one pass—multiple passes are done through the model. An input image, noise is added, some intermediate time steps are obtained, and the network is only asked to predict the delta between x₂ and x₃, not the full model. The network only predicts step to step. Until a particular time step, for any diffusion model, noise is predefined in a first time step, we just add can get xₜ and xₜ₋₁ at training time. Given xₜ, the approach or goal at east step is to predict xₜ₋₁. Different models may have a different number of steps. In the reverse process shown in FIG. 2, at each step, there may be 200 steps, the inference may need to be done 200 times. For a large scale model, the approach can be treated as a fixed point titration. Slightly more intelligent scheduling can bring the process down to 50 steps. There may be minimal performance drops when 50 steps are reduced to 20 steps in the model. 20 steps is still many passes through the network, computational expensive.

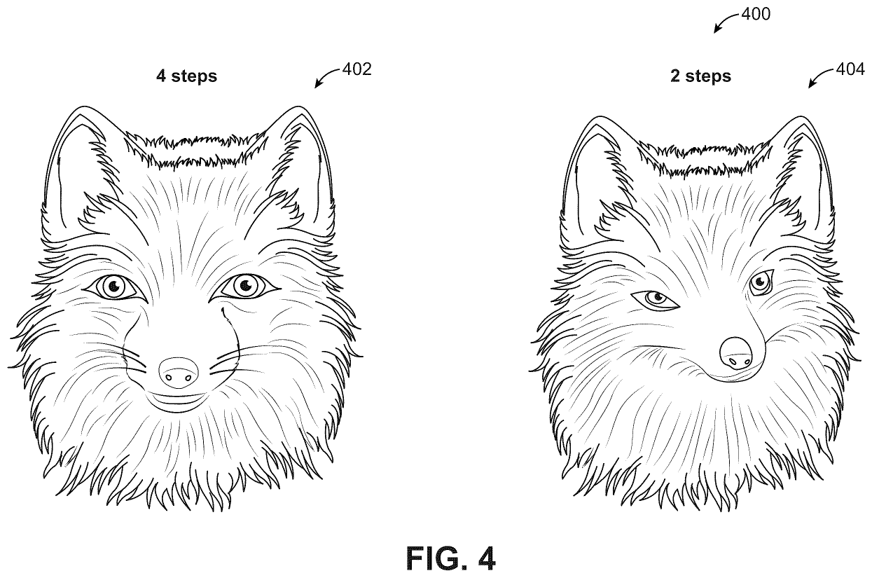

FIG. 2 is a diagram 200 illustrating how diffusion data is distributed from initial data to noise using a diffusion model in the forward diffusion direction, in accordance with some aspects. Note that the initial data q(X₀) is detailed in the initial stage of the diffusion process. An illustrative example of the data q(X₀) is the initial image of the vase shown in FIG. 1. As the diffusion model iterates and iteratively adds sampled noise to the data from t=0 to t=T, as shown in FIG. 2, the data becomes noisier and may ultimately result in pure noise (e.g., at q(X_{T})). The example of FIG. 4 illustrates the progression of the data and how the data becomes diffused with noise in the forward diffusion process.

In some aspects, the diffused data distribution as shown in FIG. 2 can be as follows:

$$q ( {x}_{t} ) = \int q ( {x}_{0} , {x}_{t} ) d {x}_{0} = \int q ( {x}_{0} ) q ( {x}_{t} \vert {x}_{0} ) d {x}_{0} .$$

In the above equation, q(xₜ) represents the diffused data distribution, q(x₀,xₜ) represents the joint distribution, q(x₀) represents the input data distribution, and q(xₜ|x₀) is the diffusion kernel. In some aspects, the model can sample xₜ˜q(xₜ) by first sampling x₀˜q(x₀) and then sampling xₜ˜q(xₜ|x₀) (which may be referred to as ancestral sampling). The diffusion kernel takes the input and returns a vector or other data structure as output.

The following is a summary of a training algorithm and a sampling algorithm for a diffusion model. A training algorithm can include the following steps:

| | |
|---|---|
| 1: | repeat |
| 2: | x₀ ~ q(x₀) |
| 3: | t ~ Uniform ({1, . . . , T}) |
| 4: | ∈ ~ [symbol] (0, I) |
| 5: | Take gradient descent step on |
| | ${∇}_{∅} {‖ ∈ - {∈}_{∅} ( \sqrt{{∝}_{t} {x}_{0}} + \sqrt{1 - {∝}_{t}} ∈ , t ) ‖}^{2}$ |
| 6: | until converged |
| | 6: |

A sampling algorithm can include the following steps:

| | |
|---|---|
| 1: | x_{T} ~ [symbol] (0,I) |
| 2: | for t = T, . . . , 1 do |
| 3: | z ~ [symbol] (0, I) |
| 4: | ${x}_{t - 1} = \frac{1}{\sqrt{{∝}_{t}}} ( {x}_{t} - \frac{1 - {∝}_{t}}{\sqrt{1 - {∝}_{t}}} {∈}_{∅} ( {x}_{t} , t ) ) + {σ}_{t} z$ |
| 5: | end for |
| 6: | return x₀ |

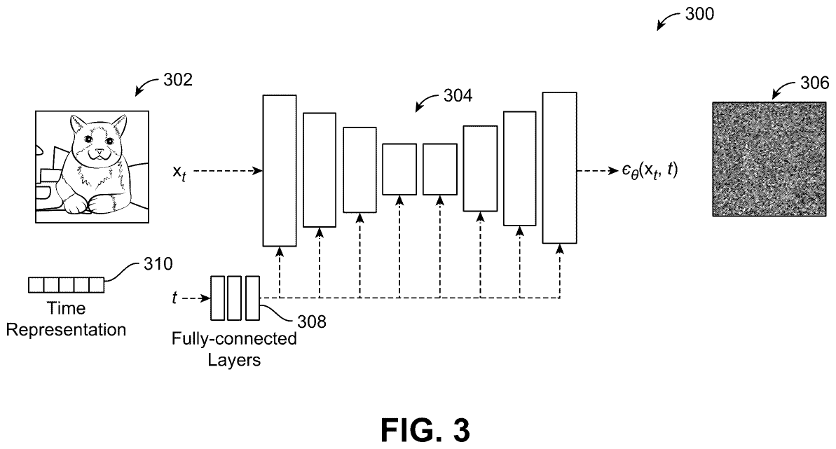

FIG. 3 is a diagram illustrating a U-Net architecture 300 for a diffusion model, in accordance with some aspects. The initial image 302 (e.g., of a vase, vehicle, person, or other object) is provided to the U-Net architecture 300 which includes a series of residual networks (ResNet) blocks and self-attention layers to represent the network ϵ_{θ} (xₜ, t). The U-Net architecture also includes fully-connected layers 308. In some cases, the time representation 310 can be sinusoidal positional embeddings or random Fourier features. The noisy output 306 from the forward diffusion process is also shown.

The U-Net architecture 300 includes a contracting path 304 and an expansive path 305 as shown in FIG. 3, which shows the U-shaped architecture. The contracting path 304 can be a convolutional network that includes repeated convolutional layers (that apply convolutional operations), each followed by a rectified linear unit (ReLU) and a max pooling operation. When images are being processed (e.g., the image 302) during the contracting path 304, the spatial information of the image 302 is reduced as features are generated. The expansive path 305 combines the features and spatial information through a sequence of up-convolutions and concatenations with high-resolution features from the contracting path. Some of the layers can be self-attention layers which leverage global interactions between semantic features at the end of the encoder to explicitly model full contextual information. Semantic information from processing data in the various layers of the U-Net architecture 300 can be provided to the auxiliary network disclosed herein to provide performance improvements for portions of the image (e.g., high frequency components) where needed when only a small number of steps are used in training or inference.

FIG. 4 illustrates a set of images 400 including a first image 402 that is generated by a four-step distillation diffusion model and which shows a certain level of detail in the hair, eyes, nose and mouth of a dog. The second image 404 is generated by a two-step distillation diffusion model and shows, relative to the first image 402, less detail in the features of the dog. FIG. 4 illustrates the reduction in performance between a four-step distillation diffusion model and a two-step distillation diffusion model similar to that shown in FIG. 3.

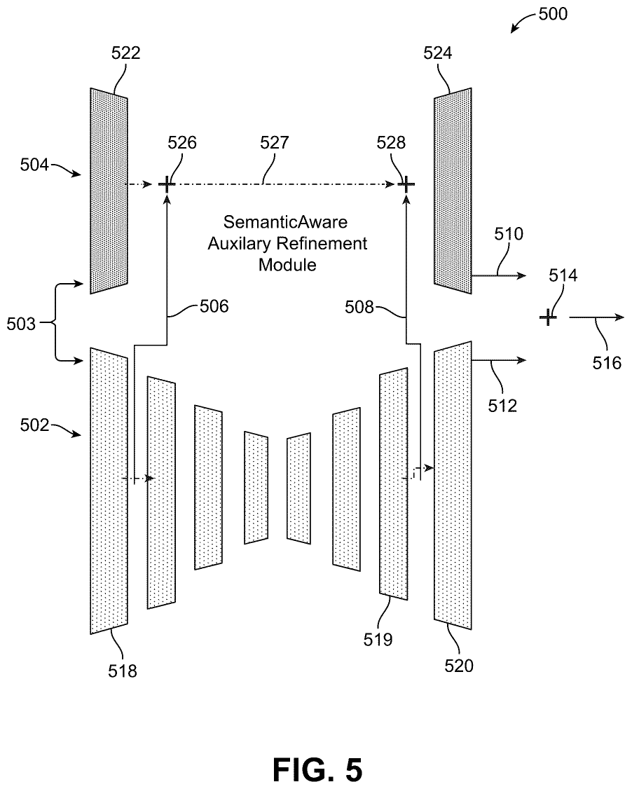

FIG. 5 illustrates an example of a system 500 for high quality step distillation. The system 500 can include a baseline diffusion network 502 (or stable diffusion model or network) and an auxiliary network 504. The auxiliary network 504 has access to all the data of the baseline diffusion network 502 and can be configured in parallel (as opposed to serially) to the baseline diffusion network 502. The approach is to add capacity independently of the baseline diffusion network 502. The auxiliary network 504 has access to all the semantic data (activations) being passed through the baseline diffusion network 502 on a layer-by-layer basis. In one aspect, the auxiliary network 504 and/or the baseline diffusion network 502 have an encoder/decoder architecture.

The baseline diffusion network 502 would have a capacity problem if it were asked to process data in say 1, 2 or 5 steps particularly for the high frequency components of images. The capacity problem, for example, can related to how much data the baseline diffusion network 502 can store. The auxiliary network 504 adds capacity (e.g., additional channels) for the high frequency components. In one aspect, the use of the auxiliary network 504 can add capacity for the first layer of the baseline diffusion network 518 and the last layer 520 of the baseline diffusion network 502.

In some aspects, the first layer of the auxiliary network 522 includes similar or the same parameters as the first layer of the baseline diffusion network 518 and the second layer of the auxiliary network 524 includes similar or the same parameters as the second layer of the baseline diffusion network 520. The first layer of the auxiliary network 522 and the second layer of the auxiliary network 524 may start with similar parameters but after training and back-propagation, they will have different weight values. The respective layers are independently updated and they will likely end up with different parameter or weight values.

In some aspects, there may or may not be other layers in the auxiliary network 504. In some aspects, the initialization of the layers is the same between the baseline diffusion network 502 and the auxiliary network 504 and may be achieved by copying the weights from the first layer of the baseline diffusion network 518 to the first layer of the auxiliary network 522 and from the second layer of the baseline diffusion network 520 to the second layer of the auxiliary network 524. The respective layers may be randomly initialized as well.

One way of training the auxiliary network 504 includes using the gradients generated through training in the first layer of the auxiliary network 522 and the second layer of the auxiliary network 524 and provide the weights back to the first layer of the baseline diffusion network 518 and the second layer of the auxiliary network 524. Given that the baseline diffusion network 502 is losing details of the frequency components, the additional channels in the auxiliary network 504 will be used to select the residuals for the high frequency components.

As noted above, some stable diffusion models may include an additional model or network configured serially after the baseline diffusion network 502 that may perform some basic image processing to improve the quality. However, the use of the auxiliary network 504 provides an improvement in quality when a small number of steps are used to process images or other data.

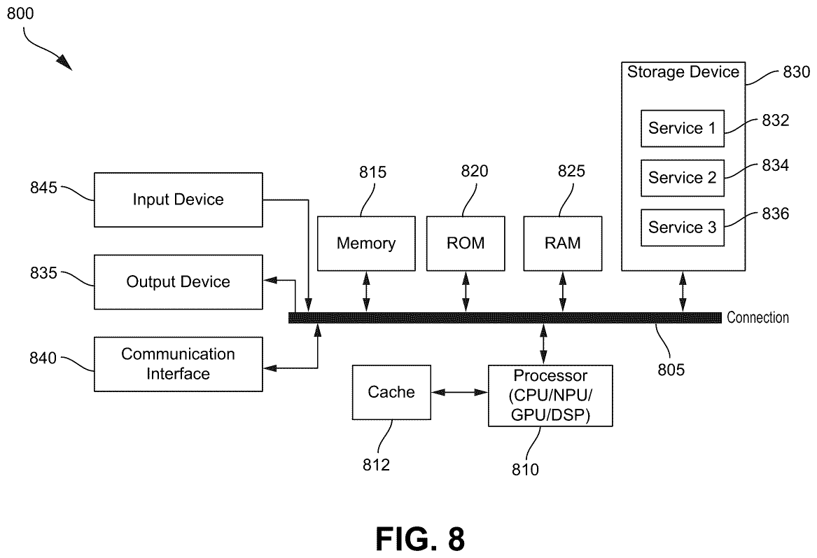

The use of the auxiliary network 504 can be dynamic or variable as well. In some cases, the auxiliary network 504 may be used only at training time or during a portion of the training time such as at the beginning for one or more steps (e.g., a “training only” implementation of the auxiliary network 504). In other aspects, the auxiliary network 504 can be used both at training and inference. In some cases, the auxiliary network 504 can be applied in a multi-stage implementation, where the auxiliary network 504 can apply to other levels or stages. For instance, during training (e.g., to compensate for optimization challenges), the auxiliary network 504 may be used for some training passes or iterations, such as at a beginning of the training, to provide initial improved weight generation. In some passes as part of a training process, the auxiliary network 504 may be dropped out and the training is performed only using the baseline diffusion network 502. The auxiliary network 504 may be added if computing power is available or can be scheduled for use at an edge node or mobile device given other computing needs of the device. Adding capacity to compensate for the loss of quality for a step-distillation diffusion model is the primary use of the auxiliary network 504 as described above. Furthermore, as noted below, the auxiliary network 504 and the baseline diffusion network 502 may both be operational on the same hardware or virtual computing components or may be configured on different processors such that one network (the auxiliary network 504 or the baseline diffusion network 502) operates on a first type of processor (e.g., a processor 810 as a CPU in FIG. 8) and the other network (the auxiliary network 504 or the baseline diffusion network 502) operates on a second type of processor (e.g., the processor 810 as a GPU in FIG. 8). The two processors may be different types of processors.

In one aspect, input data 503 is provided to both a baseline diffusion network 502 and an auxiliary network 504 at a first layer of the baseline diffusion network 518 and a first layer of the auxiliary network 522. Activations 506 generated by the first layer of the baseline diffusion network 518 are combined (e.g., added via an adder 526) to activations of the first layer of the auxiliary network 522 to generate combined activations 527. Activations 508 generated from a penultimate layer of the baseline diffusion network 519 are combined (e.g., added via an adder 528) to the combined activations 527 and provided to a last layer of the auxiliary network 524, which generates output activations of the auxiliary network 510 or second combined activations which are input to the last layer of the auxiliary network 524 which generates output activations of the auxiliary network 510. Output activations of the baseline diffusion network 512 are combined (e.g., added via an adder 514) to the output activations of the auxiliary network 510 to generate the output 516. The output 516 may be used for training the baseline diffusion network 502 or at inference time to generate images from text or audio or for any other purpose for which the baseline diffusion network 502 is trained.

In some aspects, the activations shared from the baseline diffusion network 502 to the auxiliary network 504 can be retrieved from different layers than those shown in FIG. 5. For example, the activations 506 can come from any of the first group of layers (e.g., one of the first three or four layers of the baseline diffusion network 502) in the baseline diffusion network 502 and the activations 508 may be provided from any one of the later group of layers in the baseline diffusion network 502 (e.g., one of the last three or four layers of the baseline diffusion network 502).

The use of the auxiliary network 504 can be intermittent, random, or purposefully used as part of a training process or an inference process. For example, an analysis could be done of the input data 503 to determine whether there are certain characteristics of the input data 503 (e.g., complexity, color variations, video characteristics, textual information, semantic information, high frequency components, etc.) which will tax the resources of the device training or operating the baseline diffusion network 502 and thus may cause an approach to implement an additional channel for processing data using the auxiliary network 504. The insertion or application of the auxiliary network 504 may also be based on a quality of service requirement, or a predicted image quality level, available computing capacity, or other factors.

By passing the first activations 506 and/or second activations 508 from the baseline diffusion network 502 to the auxiliary network 504, semantic information can be provided to the auxiliary network 504 which can provide necessary computational resources to train or infer data for the baseline diffusion network 502. In this regard, the auxiliary network 504 can be referred to as a semantic-aware auxiliary refinement module which can be used for a portion of a training or inference process or for all of the process. The auxiliary network 504 can be inserted or applied for a portion of the process and then dropped out for other portions where its additional channel for processing data is not as beneficial.

The auxiliary network 504 allows generation tasks to be distilled to fewer steps with minimal quality loss compared to not using the auxiliary network 504. The result in effect is a faster generation result. One can show that using the auxiliary network 504 can produce better visual results in fewer iterations.

In some aspects, the baseline diffusion network 502 and the auxiliary network 504 can be configured on the same hardware or virtual machine. For example, the baseline diffusion network 502 and the auxiliary network 504 may both operate on the same computing device 800 shown in FIG. 8. However, in some cases, a hybrid environment may be used. The processor 810 in FIG. 8 may represent a GPU (graphics processing unit) which is versatile and excels in handling graphics rendering and parallel tasks. In one example, the processor 810 may be a Central Processing Unit (CPU) that is a general-purpose processor of the computing system 800 that handles a wide range of tasks. In another example, the processor 810 may be a Neural Processing Unit (NPU), which can be used to accelerate deep learning algorithms. In another example, the processor 810 may be a digital signal processor (DSP). In some aspects, the baseline diffusion network 502 may run on a first computing system 800 and/or first type of processor 810 and the auxiliary network 504 may run on a second computing system 800 and/or a second type of processor 810. The hybrid approach can be implemented as part of training or at inference. The first type of processor 810 can be a CPU, NPU, or a GPU. The first type could also be a digital signal processor DSP or some other type of processor as discussed below. The second type of processor 810 can be a different type of processor than the first type of processor.

In some aspects, the auxiliary network 504 can be considered a type of adaptor that can be used for personalization applications to enhance high-frequency details and/or details for various applications. For example, if the auxiliary network 504 is considered as an adaptor for high-frequency components, then the auxiliary network 504 can be adopted for applications which required on-device learning. In some cases, physical components can be added to a computing system 800 such as one or more cameras, microphones, video cameras, sensors, antennas, modems, etc. that may be used for training or inference. For example, a computing system 800 may include a camera that enable a person to take a picture of a cat and then instruct the computing system 800 to “put a blue hat on the cat”. The baseline diffusion network 502 and/or the auxiliary network 504 may be configured to interact with some other hardware or physical component (or virtual component as well) at inference or for generative operations.

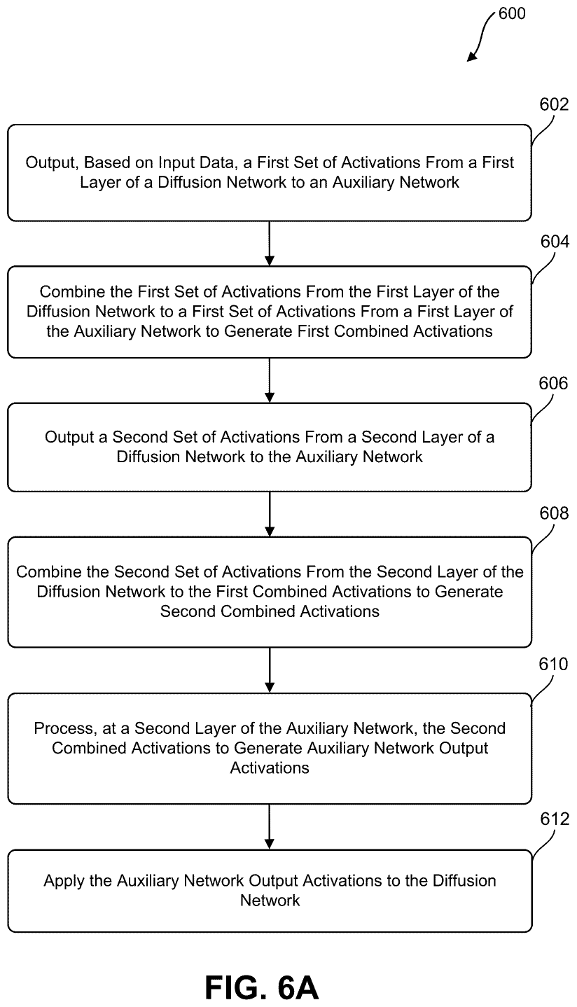

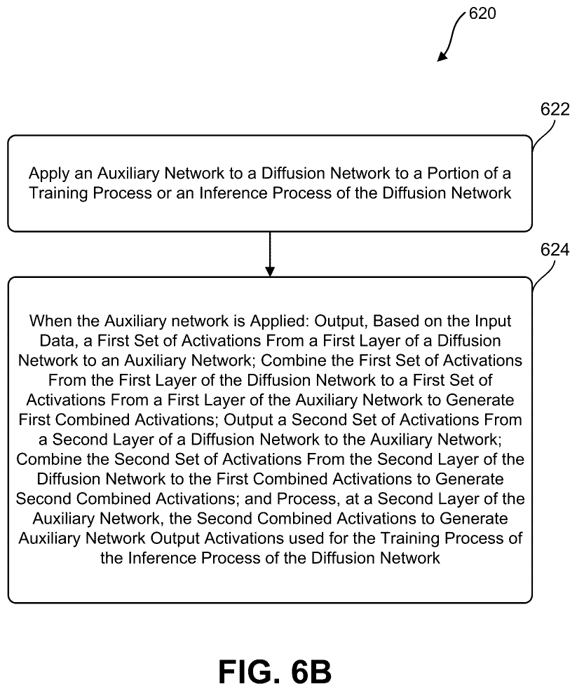

FIG. 6A is a flowchart illustrating an example process 600 for providing a generative model based on input using one or more of the techniques described herein. In one example, the process 600 can be performed by a computing device or a component or system (e.g., one or more chipsets, one or more processors such as one or more CPUs, DSPs, GPUs, NPUs, NSPs, microcontrollers, ASICs, FPGAs, programmable logic devices, discrete gates or transistor logic components, discrete hardware components, etc., an ML system such as a neural network model, any combination thereof, and/or other component or system) of the computing device. In some aspects, the computing device or component or system thereof can be or can include one or more of the system 500, the computing system 800, a combination thereof, or other device or system. For instance, a computing device with the computing device architecture of the computing system 800 shown in FIG. 8 can implement the operations of FIG. 6A, FIG. 6B and/or the components and/or operations described herein with respect to any of FIGS. 1, 3, 5, 6A and/or 6B. The operations of the process 600 may be implemented as software components that are executed and run on one or more processors (e.g., processor 810 of FIG. 8 or other processor(s)).

At operation 602, the computing device (or component or system thereof) can output, based on the input data (e.g., input data 503 of FIG. 5), a first set of activations (e.g., activations 526) from a first layer of a diffusion network (e.g., the baseline diffusion network 502 having a first layer 518) to an auxiliary network (e.g., the auxiliary network 504, which can be a semantic-aware auxiliary refinement module as described herein). In some examples, the first layer of the diffusion network (e.g., diffusion network 502) can include one of a first three layers of the diffusion network and the second layer of the diffusion network can include one of a last three layers of the diffusion network. In some aspects, the diffusion network can include a step-distillation diffusion network.

At operation 604, the computing device (or component or system thereof) can combine (e.g., add, concatenate, average, or otherwise combine) the first set of activations from the first layer of the diffusion network (e.g., the first layer of the diffusion network 518) to a first set of activations from a first layer of the auxiliary network (e.g., the first layer of the auxiliary network 522) to generate first combined activations (e.g., combined activations 527 of FIG. 5).

At operation 606, the computing device (or component or system thereof) can output a second set of activations (e.g., activations 508) from a second layer of a diffusion network (e.g., the penultimate layer of the diffusion network 519) to the auxiliary network.

At operation 608, the computing device (or component or system thereof) can combine (e.g., add, concatenate, average, or otherwise combine) the second set of activations from the second layer of the diffusion network to the first combined activations to generate second combined activations (e.g., the combined activations output from adder 528).

At operation 610, the computing device (or component or system thereof) can process, at a second layer of the auxiliary network (e.g., the second layer of the auxiliary network 524), the second combined activations to generate auxiliary network output activations (e.g., output activations 510 from the auxiliary network 504).

At operation 612, the computing device (or component or system thereof) can apply the auxiliary network output activations to the diffusion network.

In another operation, the computing device (or component or system thereof) can train the diffusion network using the auxiliary network output activations or may use the auxiliary network output activations for inference or for generative modeling.

In another operation, the computing device (or component or system thereof) can combine (e.g., add, concatenate, average, or otherwise combine) the auxiliary network output activations to diffusion network output activations to generate combined output activations (e.g., output activations 516 of FIG. 5). The combined output activations may be used to train the diffusion network (e.g., diffusion network 502) and/or at inference time for generative modeling such as to perform inference using the diffusion network based on the combined output activations.

In some aspects, the auxiliary network (e.g., auxiliary network 504) is used for processing high frequency components associated with input data 503. In some cases, the auxiliary network is a semantic-aware auxiliary network that is used for at least a portion of a training process or inference process. For instance, when training the diffusion network (e.g., the diffusion network 502), the auxiliary network (e.g., the auxiliary network 504) can be used for a portion of a training process. In one illustrative example, the auxiliary network 504 can be used for a first portion of the training process and thereafter the auxiliary network is dropped out of the training process. The portion of the training process in which the auxiliary network is used can be chosen randomly, chosen based on a characteristic of data being processed, chosen based on a desired quality, chosen based on an amount of processing needed to process the data, chosen based on a layer associated with one of more of the diffusion network and the auxiliary network, any combination thereof, and/or based on other factors. In some aspects, as described herein, the auxiliary network is not used during inference of the diffusion network (e.g., the auxiliary network may be a “training only” component of the diffusion network).

In some aspects, when training the diffusion network 502, the first layer of the auxiliary network 522 and the second layer of the auxiliary network 524 can be initialized either randomly or using weights from the first layer of the diffusion network 518 and the second layer of the diffusion network 520.

In some aspects, the computing device (or component or system thereof) is configured on an edge device of a network or on a mobile device.

In some aspects, the computing device (or component or system thereof) can include an apparatus to provide generative modeling. The apparatus can include one or more memories (e.g., memory 815, ROM 820, RAM 825, cache 812 or combination thereof) configured to store the input data (e.g., input data 503) and one or more processors (e.g., processor 810) coupled to the one or more memories and configured to perform the operations of the process 600. In some aspects, a non-transitory computer-readable medium having stored thereon instructions which, when executed by one or more processors, cause the one or more processors to perform operations of the process 600. In another example, an apparatus can include one or more means for performing operations of the process 600.

FIG. 6B is a flowchart illustrating an example process 620 for providing a generative model using one or more of the techniques described herein. In one example, the process 620 can be performed by a computing device or a component or system (e.g., one or more chipsets, one or more processors such as one or more CPUs, DSPs, NPUs, NSPs, microcontrollers, ASICs, FPGAs, programmable logic devices, discrete gates or transistor logic components, discrete hardware components, etc., an ML system such as a neural network model, any combination thereof, and/or other component or system) of the computing device. In some aspects, the computing device or component or system thereof can be or can include one or more of the system 500, the computing system 800, a combination thereof, or other device or system. For instance, a computing device with the computing device architecture of the computing system 800 shown in FIG. 8 can implement the operations of FIG. 6A, FIG. 6B and/or the components and/or operations described herein with respect to any of FIGS. 1, 3, 5, 6A and/or 6B. The operations of the process 620 may be implemented as software components that are executed and run on one or more processors (e.g., processor 810 of FIG. 8 or other processor(s)).

At operation 622, the computing device (or component or system thereof) can apply an auxiliary network (e.g., auxiliary network 504) to a diffusion network (e.g., the diffusion network 502) to a portion of a training process or an inference process of the diffusion network. The auxiliary network can be applied in parallel to the diffusion network.

At operation 624, when the auxiliary network is applied, the computing device (or component or system thereof) can output, based on the input data, a first set of activations from a first layer of the diffusion network to the auxiliary network. The computing device (or component or system thereof) can combine the first set of activations from the first layer of the diffusion network to a first set of activations from a first layer of the auxiliary network to generate first combined activations and can output a second set of activations from a second layer of a diffusion network to the auxiliary network. The computing device (or component or system thereof) can combine the second set of activations from the second layer of the diffusion network to the first combined activations to generate second combined activations. The computing device (or component or system thereof) can further process, at a second layer of the auxiliary network, the second combined activations to generate auxiliary network output activations used for the training process or the inference process of the diffusion network.

In some aspects, the computing device (or component or system thereof) can include an apparatus to provide generative modeling. The apparatus can include one or more memories (e.g., memory 815, ROM 820, RAM 825, cache 812 or combination thereof) configured to store the input data (e.g., input data 503) and one or more processors (e.g., processor 810) coupled to the one or more memories and configured to perform the operations of the process 620. In some aspects, a non-transitory computer-readable medium having stored thereon instructions which, when executed by one or more processors, cause the one or more processors to perform operations of the process 620. In another example, an apparatus can include one or more means for performing operations of the process 620.

In some aspects, the processes described herein (e.g., processes 600 and/or 620 and/or any other process described herein) may be performed by a computing device or apparatus. For instance, as noted above, the processes 600 and/or 620 can be performed by any one or more of the system 500, the computing system 800, or at least one component or system (e.g., subsystem) thereof. For instance, a computing device with the computing device architecture of the computing system 800 shown in FIG. 8 can implement the operations of FIG. 6A and/or FIG. 6B and/or operations described herein with respect to any of FIGS. 1, 3 and/or 5.

The computing device can include any suitable device, such as a mobile device (e.g., a mobile phone), a desktop computing device, a tablet computing device, an XR device (e.g., a VR headset, an AR headset, AR glasses, etc.), a wearable device (e.g., a network-connected watch or smartwatch, or other wearable device), a server computer, a vehicle (e.g., an autonomous vehicle) or computing device of the vehicle, a robotic device, a laptop computer, a smart television, a camera, and/or any other computing device with the resource capabilities to perform the processes described herein, including the processes 600 and/or 620 and/or any other process described herein. In some cases, the computing device or apparatus may include various components, such as one or more input devices, one or more output devices, one or more processors, one or more microprocessors, one or more microcomputers, one or more cameras, one or more sensors, and/or other component(s) that are configured to carry out the steps of processes described herein. In some examples, the computing device may include a display, a network interface configured to communicate and/or receive the data, any combination thereof, and/or other component(s). The network interface may be configured to communicate and/or receive Internet Protocol (IP) based data or other type of data.

The components of the computing device can be implemented in circuitry. For example, the components can include and/or can be implemented using electronic circuits or other electronic hardware, which can include one or more programmable electronic circuits (e.g., microprocessors, graphics processing units (GPUs), digital signal processors (DSPs), central processing units (CPUs), and/or other suitable electronic circuits), and/or can include and/or be implemented using computer software, firmware, or any combination thereof, to perform the various operations described herein.

The processes 600 and/or 620 are illustrated as logical flow diagrams, the operation of which represents a sequence of operations that can be implemented in hardware, computer instructions, or a combination thereof. In the context of computer instructions, the operations represent computer-executable instructions stored on one or more computer-readable storage media that, when executed by one or more processors, perform the recited operations. Generally, computer-executable instructions include routines, programs, objects, components, data structures, and the like that perform particular functions or implement particular data types. The order in which the operations are described is not intended to be construed as a limitation, and any number of the described operations can be combined in any order and/or in parallel to implement the processes.

Additionally, the 600 and/or 620 and/or any other process described herein may be performed under the control of one or more computer systems configured with executable instructions and may be implemented as code (e.g., executable instructions, one or more computer programs, or one or more applications) executing collectively on one or more processors, by hardware, or combinations thereof. As noted above, the code may be stored on a computer-readable or machine-readable storage medium, for example, in the form of a computer program comprising a plurality of instructions executable by one or more processors. The computer-readable or machine-readable storage medium may be non-transitory.

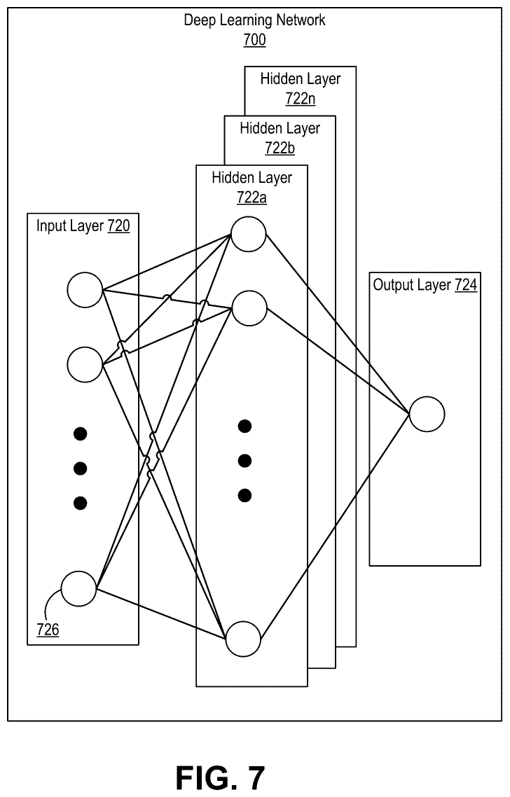

As described herein, the neural network 700 of FIG. 7 may be implemented using a neural network or multiple neural networks. FIG. 7 is an illustrative example of a deep learning neural network 700 that can be used by the neural network 700 of FIG. 7. An input layer 720 includes input data. In one illustrative example, the input layer 720 can include data representing the pixels of an input video frame. The neural network 700 includes multiple hidden layers 722a, 722b, through 722n. The hidden layers 722a, 722b, through 722n include “n” number of hidden layers, where “n” is an integer greater than or equal to one. The number of hidden layers can be made to include as many layers as needed for the given application. The neural network 700 further includes an output layer 724 that provides an output resulting from the processing performed by the hidden layers 722a, 722b, through 722n. In one illustrative example, the output layer 724 can provide a classification for an object in an input video frame. The classification can include a class identifying the type of object (e.g., a person, a dog, a cat, or other object).

The neural network 700 is a multi-layer neural network of interconnected nodes. Each node can represent a piece of information. Information associated with the nodes is shared among the different layers and each layer retains information as information is processed. In some cases, the neural network 700 can include a feed-forward network, in which case there are no feedback connections where outputs of the network are fed back into itself. In some cases, the neural network 700 can include a recurrent neural network, which can have loops that allow information to be carried across nodes while reading in input.

Information can be exchanged between nodes through node-to-node interconnections between the various layers. Nodes of the input layer 720 can activate a set of nodes in the first hidden layer 722a. For example, as shown, each of the input nodes of the input layer 720 is connected to each of the nodes of the first hidden layer 722a. The nodes of the hidden layers 722a, 722b, through 722n can transform the information of each input node by applying activation functions to the information. The information derived from the transformation can then be passed to and can activate the nodes of the next hidden layer 722b, which can perform their own designated functions. Example functions include convolutional, up-sampling, data transformation, and/or any other suitable functions. The output of the hidden layer 722b can then activate nodes of the next hidden layer, and so on. The output of the last hidden layer 722n can activate one or more nodes of the output layer 724, at which an output is provided. In some cases, while nodes (e.g., node 727) in the neural network 700 are shown as having multiple output lines, a node has a single output and all lines shown as being output from a node represent the same output value.

In some cases, each node or interconnection between nodes can have a weight that is a set of parameters derived from the training of the neural network 700. Once the neural network 700 is trained, it can be referred to as a trained neural network, which can be used to classify one or more objects. For example, an interconnection between nodes can represent a piece of information learned about the interconnected nodes. The interconnection can have a tunable numeric weight that can be tuned (e.g., based on a training dataset), allowing the neural network 700 to be adaptive to inputs and able to learn as more and more data is processed.

The neural network 700 is pre-trained to process the features from the data in the input layer 720 using the different hidden layers 722a, 722b, through 722n in order to provide the output through the output layer 724. In an example in which the neural network 700 is used to identify objects in images, the neural network 700 can be trained using training data that includes both images and labels. For instance, training images can be input into the network, with each training image having a label indicating the classes of the one or more objects in each image (basically, indicating to the network what the objects are and what features they have). In one illustrative example, a training image can include an image of a number 2, in which case the label for the image can be [0 0 1 0 0 0 0 0 0 0].

In some cases, the neural network 700 can adjust the weights of the nodes using a training process referred to as backpropagation. Backpropagation can include a forward pass, a loss function, a backward pass, and a weight update. The forward pass, loss function, backward pass, and parameter update is performed for one training iteration. The process can be repeated for a certain number of iterations for each set of training images until the neural network 700 is trained well enough so that the weights of the layers are accurately tuned.

For the example of identifying objects in images, the forward pass can include passing a training image through the neural network 700. The weights are initially randomized before the neural network 700 is trained. The image can include, for example, an array of numbers representing the pixels of the image. Each number in the array can include a value from 0 to 255 describing the pixel intensity at that position in the array. In one example, the array can include a 28×28×3 array of numbers with 28 rows and 28 columns of pixels and 3 color components (such as red, green, and blue, or luma and two chroma components, or the like).

For a first training iteration for the neural network 700, the output will likely include values that do not give preference to any particular class due to the weights being randomly selected at initialization. For example, if the output is a vector with probabilities that the object includes different classes, the probability value for each of the different classes may be equal or at least very similar (e.g., for ten possible classes, each class may have a probability value of 0.1). With the initial weights, the neural network 700 is unable to determine low level features and thus cannot make an accurate determination of what the classification of the object might be. A loss function can be used to analyze error in the output. Any suitable loss function definition can be used. One example of a loss function includes a mean squared error (MSE). The MSE is defined as

$${E}_{total} = \sum \frac{1}{2} {( target - output )}^{2} ,$$

which calculate the sum of one-half times a ground truth output (e.g., the actual answer) minus the predicted output (e.g., the predicted answer) squared. The loss can be set to be equal to the value of Eₜₒₜₐₗ.

The loss (or error) will be high for the first training images since the actual values will be much different than the predicted output. The goal of training is to minimize the amount of loss so that the predicted output is the same as the training label. The neural network 700 can perform a backward pass by determining which inputs (weights) most contributed to the loss of the network, and can adjust the weights so that the loss decreases and is eventually minimized.

A derivative of the loss with respect to the weights (denoted as dL/dW, where W are the weights at a particular layer) can be computed to determine the weights that contributed most to the loss of the network. After the derivative is computed, a weight update can be performed by updating all the weights of the filters. For example, the weights can be updated so that they change in the opposite direction of the gradient. The weight update can be denoted as

$$w = {w}_{i} - η \frac{d L}{d W} ,$$

where w denotes a weight, wᵢ denotes the initial weight, and η denotes a learning rate. The learning rate can be set to any suitable value, with a high learning rate including larger weight updates and a lower value indicating smaller weight updates.

In some cases, the neural network 700 can be trained using self-supervised learning.

The neural network 700 can include any suitable deep network. One example includes a convolutional neural network (CNN), which includes an input layer and an output layer, with multiple hidden layers between the input and out layers. An example of a CNN is described below with respect to FIG. 8. The hidden layers of a CNN include a series of convolutional, nonlinear, pooling (for downsampling), and fully connected layers. The neural network 700 can include any other deep network other than a CNN, such as an autoencoder, a deep belief nets (DBNs), a Recurrent Neural Networks (RNNs), among others.

In some aspects, training of one or more of the machine learning systems or neural networks described herein (e.g., such as the system 500 of FIG. 5, the neural network 700 of FIG. 7, among various other machine learning networks described herein, etc.) can be performed using online training, offline training, and/or various combinations of online and offline training. In some cases, online may refer to time periods during which the input data (e.g., such as the input data 503 of FIG. 5, etc.) is processed, for instance for performance of the semantics aware auxiliary refinement network processing implemented by the systems and techniques described herein. In some examples, offline may refer to idle time periods or time periods during which input data is not being processed. Additionally, offline may be based on one or more time conditions (e.g., after a particular amount of time has expired, such as a day, a week, a month, etc.) and/or may be based on various other conditions such as network and/or server availability, etc., among various others. In some aspects, offline training of a machine learning model (e.g., a neural network model) can be performed by a first device (e.g., a server device) to generate a pre-trained model, and a second device can receive the trained model from the second device. In some cases, the second device (e.g., a mobile device, an XR device, a vehicle or system/component of the vehicle, or other device) can perform online (or on-device) training of the pre-trained model to further adapt or tune the parameters of the model.

FIG. 8 is a diagram illustrating an example of a system for implementing certain aspects of the present disclosure. In particular, FIG. 8 illustrates an example of computing system 800, which can be for example any computing device making up a computing system, a camera system, or any component thereof in which the components of the system are in communication with each other using connection 805. Connection 805 can be a physical connection using a bus, or a direct connection into processor 812, such as in a chipset architecture. Connection 805 can also be a virtual connection, networked connection, or logical connection.

In some examples, computing system 800 is a distributed system in which the functions described in this disclosure can be distributed within a datacenter, multiple data centers, a peer network, etc. In some examples, one or more of the described system components represents many such components each performing some or all of the function for which the component is described. In some examples, the components can be physical or virtual devices.

Example system 800 includes at least one processing unit (processor which can be any one or more of a CPU, GPU, NPU, DSP, ASIC or other type of processor) 810 and connection 805 that couples various system components including system memory 815, such as read-only memory (ROM) 820 and random access memory (RAM) 825 to processor 812. Computing system 800 can include a cache 811 of high-speed memory connected directly with, in close proximity to, or integrated as part of processor 812.

Processor 812 can include any general purpose processor and a hardware service or software service, such as services 832, 834, and 836 stored in storage device 830, configured to control processor 812 as well as a special-purpose processor where software instructions are incorporated into the actual processor design. Processor 812 may essentially be a completely self-contained computing system, containing multiple cores or processors, a bus, memory controller, cache, etc. A multi-core processor may be symmetric or asymmetric.

To enable user interaction, computing system 800 includes an input device 845, which can represent any number of input mechanisms, such as a microphone for speech, a touch-sensitive screen for gesture or graphical input, keyboard, mouse, motion input, speech, etc. Computing system 800 can also include output device 835, which can be one or more of a number of output mechanisms. In some instances, multimodal systems can enable a user to provide multiple types of input/output to communicate with computing system 800. Computing system 800 can include communications interface 840, which can generally govern and manage the user input and system output.

The communication interface may perform or facilitate receipt and/or transmission wired or wireless communications using wired and/or wireless transceivers, including those making use of an audio jack/plug, a microphone jack/plug, a universal serial bus (USB) port/plug, an Apple® Lightning® port/plug, an Ethernet port/plug, a fiber optic port/plug, a proprietary wired port/plug, a BLUETOOTH® wireless signal transfer, a BLUETOOTH® low energy (BLE) wireless signal transfer, an IBEACON® wireless signal transfer, a radio-frequency identification (RFID) wireless signal transfer, near-field communications (NFC) wireless signal transfer, dedicated short range communication (DSRC) wireless signal transfer, 1202.11 Wi-Fi wireless signal transfer, wireless local area network (WLAN) signal transfer, Visible Light Communication (VLC), Worldwide Interoperability for Microwave Access (WiMAX), Infrared (IR) communication wireless signal transfer, Public Switched Telephone Network (PSTN) signal transfer, Integrated Services Digital Network (ISDN) signal transfer, 3G/4G/5G/LTE cellular data network wireless signal transfer, ad-hoc network signal transfer, radio wave signal transfer, microwave signal transfer, infrared signal transfer, visible light signal transfer, ultraviolet light signal transfer, wireless signal transfer along the electromagnetic spectrum, or some combination thereof.

The communications interface 840 may also include one or more Global Navigation Satellite System (GNSS) receivers or transceivers that are used to determine a location of the computing system 800 based on receipt of one or more signals from one or more satellites associated with one or more GNSS systems. GNSS systems include, but are not limited to, the US-based Global Positioning System (GPS), the Russia-based Global Navigation Satellite System (GLONASS), the China-based BeiDou Navigation Satellite System (BDS), and the Europe-based Galileo GNSS. There is no restriction on operating on any particular hardware arrangement, and therefore the basic features here may easily be substituted for improved hardware or firmware arrangements as they are developed.

Storage device 830 can be a non-volatile and/or non-transitory and/or computer-readable memory device and can be a hard disk or other types of computer readable media which can store data that are accessible by a computer, such as magnetic cassettes, flash memory cards, solid state memory devices, digital versatile disks, cartridges, a floppy disk, a flexible disk, a hard disk, magnetic tape, a magnetic strip/stripe, any other magnetic storage medium, flash memory, memristor memory, any other solid-state memory, a compact disc read only memory (CD-ROM) optical disc, a rewritable compact disc (CD) optical disc, digital video disk (DVD) optical disc, a blu-ray disc (BDD) optical disc, a holographic optical disk, another optical medium, a secure digital (SD) card, a micro secure digital (microSD) card, a Memory Stick® card, a smartcard chip, a EMV chip, a subscriber identity module (SIM) card, a mini/micro/nano/pico SIM card, another integrated circuit (IC) chip/card, random access memory (RAM), static RAM (SRAM), dynamic RAM (DRAM), read-only memory (ROM), programmable read-only memory (PROM), erasable programmable read-only memory (EPROM), electrically erasable programmable read-only memory (EEPROM), flash EPROM (FLASHEPROM), cache memory (L1/L2/L3/L4/L5/L #), resistive random-access memory (RRAM/ReRAM), phase change memory (PCM), spin transfer torque RAM (STT-RAM), another memory chip or cartridge, and/or a combination thereof.

The storage device 830 can include software services, servers, services, etc., that when the code that defines such software is executed by the processor 812, it causes the system to perform a function. In some examples, a hardware service that performs a particular function can include the software component stored in a computer-readable medium in connection with the necessary hardware components, such as processor 812, connection 805, output device 835, etc., to carry out the function. The term “computer-readable medium” includes, but is not limited to, portable or non-portable storage devices, optical storage devices, and various other mediums capable of storing, containing, or carrying instruction(s) and/or data. A computer-readable medium may include a non-transitory medium in which data can be stored and that does not include carrier waves and/or transitory electronic signals propagating wirelessly or over wired connections. Examples of a non-transitory medium may include, but are not limited to, a magnetic disk or tape, optical storage media such as compact disk (CD) or digital versatile disk (DVD), flash memory, memory or memory devices. A computer-readable medium may have stored thereon code and/or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, or the like.

In some aspects the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Specific details are provided in the description above to provide a thorough understanding of the aspects and examples provided herein. However, it will be understood by one of ordinary skill in the art that the aspects may be practiced without these specific details. For clarity of explanation, in some instances the present technology may be presented as including individual functional blocks comprising devices, device components, steps or routines in a method embodied in software, or combinations of hardware and software. Additional components may be used other than those shown in the figures and/or described herein. For example, circuits, systems, networks, processes, and other components may be shown as components in block diagram form in order not to obscure the aspects in unnecessary detail. In other instances, well-known circuits, processes, algorithms, structures, and techniques may be shown without unnecessary detail in order to avoid obscuring the aspects.

Individual aspects may be described above as a process or method which is depicted as a flowchart, a flow diagram, a data flow diagram, a structure diagram, or a block diagram.

Although a flowchart may describe the operations as a sequential process, many of the operations can be performed in parallel or concurrently. In addition, the order of the operations may be re-arranged. A process is terminated when its operations are completed, but could have additional steps not included in a figure. A process may correspond to a method, a function, a procedure, a subroutine, a subprogram, etc. When a process corresponds to a function, its termination can correspond to a return of the function to the calling function or the main function.

Processes and methods according to the above-described examples can be implemented using computer-executable instructions that are stored or otherwise available from computer-readable media. Such instructions can include, for example, instructions and data which cause or otherwise configure a general purpose computer, special purpose computer, or a processing device to perform a certain function or group of functions. Portions of computer resources used can be accessible over a network. The computer executable instructions may be, for example, binaries, intermediate format instructions such as assembly language, firmware, source code. Examples of computer-readable media that may be used to store instructions, information used, and/or information created during methods according to described examples include magnetic or optical disks, flash memory, USB devices provided with non-volatile memory, networked storage devices, and so on.

Devices implementing processes and methods according to these disclosures can include hardware, software, firmware, middleware, microcode, hardware description languages, or any combination thereof, and can take any of a variety of form factors. When implemented in software, firmware, middleware, or microcode, the program code or code segments to perform the necessary tasks (e.g., a computer-program product) may be stored in a computer-readable or machine-readable medium. A processor(s) may perform the necessary tasks. Typical examples of form factors include laptops, smart phones, mobile phones, tablet devices or other small form factor personal computers, personal digital assistants, rackmount devices, standalone devices, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are example means for providing the functions described in the disclosure.

In the foregoing description, aspects of the application are described with reference to specific aspects thereof, but those skilled in the art will recognize that the application is not limited thereto. Thus, while illustrative aspects of the application have been described in detail herein, it is to be understood that the inventive concepts may be otherwise variously embodied and employed, and that the appended claims are intended to be construed to include such variations, except as limited by the prior art. Various features and aspects of the above-described application may be used individually or jointly. Further, aspects can be utilized in any number of environments and applications beyond those described herein without departing from the broader spirit and scope of the specification. The specification and drawings are, accordingly, to be regarded as illustrative rather than restrictive. For the purposes of illustration, methods were described in a particular order. It should be appreciated that in alternate aspects, the methods may be performed in a different order than that described.

One of ordinary skill will appreciate that the less than (“<”) and greater than (“>”) symbols or terminology used herein can be replaced with less than or equal to (“<”) and greater than or equal to (“>”) symbols, respectively, without departing from the scope of this description.

Where components are described as being “configured to” perform certain operations, such configuration can be accomplished, for example, by designing electronic circuits or other hardware to perform the operation, by programming programmable electronic circuits (e.g., microprocessors, or other suitable electronic circuits) to perform the operation, or any combination thereof.

The phrase “coupled to” refers to any component that is physically connected to another component either directly or indirectly, and/or any component that is in communication with another component (e.g., connected to the other component over a wired or wireless connection, and/or other suitable communication interface) either directly or indirectly.

Claim language or other language reciting “at least one of” a set and/or “one or more” of a set indicates that one member of the set or multiple members of the set (in any combination) satisfy the claim. For example, claim language reciting “at least one of A and B” or “at least one of A or B” means A, B, or A and B. In another example, claim language reciting “at least one of A, B, and C” or “at least one of A, B, or C” means A, B, C, or A and B, or A and C, or B and C, A and B and C, or any duplicate information or data (e.g., A and A, B and B, C and C, A and A and B, and so on), or any other ordering, duplication, or combination of A, B, and C. The language “at least one of” a set and/or “one or more” of a set does not limit the set to the items listed in the set. For example, claim language reciting “at least one of A and B” or “at least one of A or B” may mean A, B, or A and B, and may additionally include items not listed in the set of A and B. The phrases “at least one” and “one or more” are used interchangeably herein.

Claim language or other language reciting “at least one processor configured to,” “at least one processor being configured to,” “one or more processors configured to,” “one or more processors being configured to,” or the like indicates that one processor or multiple processors (in any combination) can perform the associated operation(s). For example, claim language reciting “at least one processor configured to: X, Y, and Z” means a single processor can be used to perform operations X, Y, and Z; or that multiple processors are each tasked with a certain subset of operations X, Y, and Z such that together the multiple processors perform X, Y, and Z; or that a group of multiple processors work together to perform operations X, Y, and Z. In another example, claim language reciting “at least one processor configured to: X, Y, and Z” can mean that any single processor may only perform at least a subset of operations X, Y, and Z.

Where reference is made to one or more elements performing functions (e.g., steps of a method), one element may perform all functions, or more than one element may collectively perform the functions. When more than one element collectively performs the functions, each function need not be performed by each of those elements (e.g., different functions may be performed by different elements) and/or each function need not be performed in whole by only one element (e.g., different elements may perform different sub-functions of a function). Similarly, where reference is made to one or more elements configured to cause another element (e.g., an apparatus) to perform functions, one element may be configured to cause the other element to perform all functions, or more than one element may collectively be configured to cause the other element to perform the functions.

Where reference is made to an entity (e.g., any entity or device described herein) performing functions or being configured to perform functions (e.g., steps of a method), the entity may be configured to cause one or more elements (individually or collectively) to perform the functions. The one or more components of the entity may include at least one memory, at least one processor, at least one communication interface, another component configured to perform one or more (or all) of the functions, and/or any combination thereof. Where reference to the entity performing functions, the entity may be configured to cause one component to perform all functions, or to cause more than one component to collectively perform the functions. When the entity is configured to cause more than one component to collectively perform the functions, each function need not be performed by each of those components (e.g., different functions may be performed by different components) and/or each function need not be performed in whole by only one component (e.g., different components may perform different sub-functions of a function).

The various illustrative logical blocks, modules, circuits, and algorithm steps described in connection with the examples disclosed herein may be implemented as electronic hardware, computer software, firmware, or combinations thereof. To clearly illustrate the interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present application.

The techniques described herein may also be implemented in electronic hardware, computer software, firmware, or any combination thereof. Such techniques may be implemented in any of a variety of devices such as general purposes computers, wireless communication device handsets, or integrated circuit devices having multiple uses including application in wireless communication device handsets and other devices. Any features described as modules or components may be implemented together in an integrated logic device or separately as discrete but interoperable logic devices. If implemented in software, then the techniques may be realized at least in part by a computer-readable data storage medium comprising program code including instructions that, when executed, performs one or more of the methods, algorithms, and/or operations described above. The computer-readable data storage medium may form part of a computer program product, which may include packaging materials. The computer-readable medium may comprise memory or data storage media, such as random access memory (RAM) such as synchronous dynamic random access memory (SDRAM), read-only memory (ROM), non-volatile random access memory (NVRAM), electrically erasable programmable read-only memory (EEPROM), FLASH memory, magnetic or optical data storage media, and the like. The techniques additionally, or alternatively, may be realized at least in part by a computer-readable communication medium that carries or communicates program code in the form of instructions or data structures and that can be accessed, read, and/or executed by a computer, such as propagated signals or waves.

The program code may be executed by a processor, which may include one or more processors, such as one or more digital signal processors (DSPs), general purpose microprocessors, an application specific integrated circuits (ASICs), field programmable logic arrays (FPGAs), or other equivalent integrated or discrete logic circuitry. Such a processor may be configured to perform any of the techniques described in this disclosure. A general purpose processor may be a microprocessor; but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Accordingly, the term “processor,” as used herein may refer to any of the foregoing structure, any combination of the foregoing structure, or any other structure or apparatus suitable for implementation of the techniques described herein.

Illustrative aspects of the present disclosure include:

Aspect 1. An apparatus to provide generative modeling, the apparatus comprising: one or more memories configured to store input data; and one or more processors coupled to the one or more memories and configured to: output, based on the input data, a first set of activations from a first layer of a diffusion network to an auxiliary network; combine the first set of activations from the first layer of the diffusion network to a first set of activations from a first layer of the auxiliary network to generate first combined activations; output a second set of activations from a second layer of a diffusion network to the auxiliary network; combine the second set of activations from the second layer of the diffusion network to the first combined activations to generate second combined activations; process, at a second layer of the auxiliary network, the second combined activations to generate auxiliary network output activations; and apply the auxiliary network output activations to the diffusion network.

Aspect 2. The apparatus of Aspect 1, wherein the first layer of the diffusion network comprises one of a first three layers of the diffusion network and wherein the second layer of the diffusion network comprises one of a last three layers of the diffusion network.

Aspect 3. The apparatus of any one of Aspects 1 or 2, wherein the one or more processors are configured to: train the diffusion network using the auxiliary network output activations.

Aspect 4. The apparatus of any one of Aspects 1 to 3, wherein the one or more processors are configured to: combine the auxiliary network output activations to diffusion network output activations to generate combined output activations.

Aspect 5. The apparatus of Aspect 4, wherein the one or more processors are configured to: train the diffusion network using the combined output activations.

Aspect 6. The apparatus of any one of Aspects 4 or 5, wherein the one or more processors are configured to: perform inference using the diffusion network based on the combined output activations.

Aspect 7. The apparatus of any one of Aspects 1 to 6, wherein the diffusion network comprises a step-distillation diffusion network.

Aspect 8. The apparatus of any one of Aspects 1 to 7, wherein the auxiliary network is optionally used for processing high frequency components associated with data.

Aspect 9. The apparatus of any one of Aspects 1 to 8, wherein, when training the diffusion network, the auxiliary network is used for a portion of a training process.

Aspect 10. The apparatus of Aspect 9, wherein, when training the diffusion network, the auxiliary network is used for a first portion of the training process and thereafter the auxiliary network is dropped out of the training process.

Aspect 11. The apparatus of any one of Aspects 9 or 10, wherein the portion of the training process in which the auxiliary network is used is at least one of: chosen randomly, chosen based on a characteristic of data being processed, chosen based on a desired quality, chosen based on an amount of processing needed to process the data, or chosen based on a layer associated with one of more of the diffusion network and the auxiliary network.

Aspect 12. The apparatus of any one of Aspects 1 to 11, wherein, when training the diffusion network, the first layer of the auxiliary network and the second layer of the auxiliary network are initialized either randomly or using weights from the first layer of the diffusion network and the second layer of the diffusion network.

Aspect 13. The apparatus of any one of Aspects 1 to 12, wherein the auxiliary network is not used during inference of the diffusion network.

Aspect 14. The apparatus of any one of Aspects 1 to 13, wherein the auxiliary network comprises a semantic-aware auxiliary network that is used for a portion of a training process or inference process.

Aspect 15. A method of generative modeling, the method comprising: outputting, based on input data, a first set of activations from a first layer of a diffusion network to an auxiliary network; combining the first set of activations from the first layer of the diffusion network to a first set of activations from a first layer of the auxiliary network to generate first combined activations; outputting a second set of activations from a second layer of a diffusion network to the auxiliary network; combining the second set of activations from the second layer of the diffusion network to the first combined activations to generate second combined activations; processing, at a second layer of the auxiliary network, the second combined activations to generate auxiliary network output activations; and applying the auxiliary network output activations to the diffusion network.

Aspect 16. The method of Aspect 15, wherein the first layer of the diffusion network comprises one of a first three layers of the diffusion network and wherein the second layer of the diffusion network comprises one of a last three layers of the diffusion network.

Aspect 17. The method of any one of Aspects 15 or 16, further comprising: training the diffusion network using the auxiliary network output activations.

Aspect 18. The method of any one of Aspects 15 to 17, further comprising: combining the auxiliary network output activations to diffusion network output activations to generate combined output activations.

Aspect 19. The method of Aspect 18, further comprising: training the diffusion network using the combined output activations.

Aspect 20. The method of any one of Aspects 18 or 19, further comprising: performing inference using the diffusion network based on the combined output activations.

Aspect 21. The method of any one of Aspects 15 to 20, wherein the diffusion network comprises a step-distillation diffusion network.

Aspect 22. The method of any one of Aspects 15 to 21, wherein the auxiliary network is optionally used for processing high frequency components associated with data.

Aspect 23. The method of any one of Aspects 15 to 22, wherein, when training the diffusion network, the auxiliary network is used for a portion of a training process.

Aspect 24. The method of Aspect 23, wherein, when training the diffusion network, the auxiliary network is used for a first portion of the training process and thereafter the auxiliary network is dropped out of the training process.

Aspect 25. The method of any one of Aspects 23 or 24, wherein the portion of the training process in which the auxiliary network is used is at least one of: chosen randomly, chosen based on a characteristic of data being processed, chosen based on a desired quality, chosen based on an amount of processing needed to process the data, or chosen based on a layer associated with one of more of the diffusion network and the auxiliary network.

Aspect 26. The method of any one of Aspects 15 to 25, wherein, when training the diffusion network, the first layer of the auxiliary network and the second layer of the auxiliary network are initialized either randomly or using weights from the first layer of the diffusion network and the second layer of the diffusion network.

Aspect 27. The method of any one of Aspects 15 to 26, wherein the auxiliary network is not used during inference of the diffusion network.

Aspect 28. The method of any one of Aspects 15 to 27, wherein the auxiliary network comprises a semantic-aware auxiliary network that is used for a portion of a training process or inference process.

Aspect 29. An apparatus to provide generative modeling, the apparatus comprising: means for outputting, based on input data, a first set of activations from a first layer of a diffusion network to an auxiliary network; means for combining the first set of activations from the first layer of the diffusion network to a first set of activations from a first layer of the auxiliary network to generate first combined activations; means for outputting a second set of activations from a second layer of a diffusion network to the auxiliary network; means for combining the second set of activations from the second layer of the diffusion network to the first combined activations to generate second combined activations; means for processing, at a second layer of the auxiliary network, the second combined activations to generate auxiliary network output activations; and means for applying the auxiliary network output activations to the diffusion network.

Aspect 30. A non-transitory computer-readable medium having stored thereon instructions that, when executed by one or more processors, cause the one or more processors to: output, based on input data, a first set of activations from a first layer of a diffusion network to an auxiliary network; combine the first set of activations from the first layer of the diffusion network to a first set of activations from a first layer of the auxiliary network to generate first combined activations; output a second set of activations from a second layer of a diffusion network to the auxiliary network; combine the second set of activations from the second layer of the diffusion network to the first combined activations to generate second combined activations; process, at a second layer of the auxiliary network, the second combined activations to generate auxiliary network output activations; and apply the auxiliary network output activations to the diffusion network.

Aspect 31. An apparatus to providing generative modeling based on input data, comprising: one or more memories configured to store the input data; and one or more processors coupled to the one or more memories and configured to: apply an auxiliary network to a diffusion network to a portion of a training process or an inference process of the diffusion network; and when the auxiliary network is applied: output, based on the input data, a first set of activations from a first layer of the diffusion network to the auxiliary network; combine the first set of activations from the first layer of the diffusion network to a first set of activations from a first layer of the auxiliary network to generate first combined activations; output a second set of activations from a second layer of a diffusion network to the auxiliary network; combine the second set of activations from the second layer of the diffusion network to the first combined activations to generate second combined activations; and process, at a second layer of the auxiliary network, the second combined activations to generate auxiliary network output activations used for the training process or the inference process of the diffusion network.

Aspect 32. A method of providing generative modeling based on input data, the method comprising: applying an auxiliary network to a diffusion network to a portion of a training process or an inference process of the diffusion network; and when the auxiliary network is applied: outputting, based on the input data, a first set of activations from a first layer of the diffusion network to the auxiliary network; combining the first set of activations from the first layer of the diffusion network to a first set of activations from a first layer of the auxiliary network to generate first combined activations; outputting a second set of activations from a second layer of a diffusion network to the auxiliary network; combining the second set of activations from the second layer of the diffusion network to the first combined activations to generate second combined activations; and processing, at a second layer of the auxiliary network, the second combined activations to generate auxiliary network output activations used for the training process or the inference process of the diffusion network.

Aspect 33. An apparatus to provide a generative model based on input data, the apparatus comprising: means for applying an auxiliary network to a diffusion network to a portion of a training process or an inference process of the diffusion network; and means for, when the auxiliary network is applied: outputting, based on the input data, a first set of activations from a first layer of the diffusion network to the auxiliary network; combining the first set of activations from the first layer of the diffusion network to a first set of activations from a first layer of the auxiliary network to generate first combined activations; outputting a second set of activations from a second layer of a diffusion network to the auxiliary network; combining the second set of activations from the second layer of the diffusion network to the first combined activations to generate second combined activations; and processing, at a second layer of the auxiliary network, the second combined activations to generate auxiliary network output activations used for the training process or the inference process of the diffusion network.

Aspect 34. A non-transitory computer-readable medium having stored thereon instructions that, when executed by one or more processors, cause the one or more processors to: apply an auxiliary network to a diffusion network to a portion of a training process or an inference process of the diffusion network; and when the auxiliary network is applied: output, based on the input data, a first set of activations from a first layer of the diffusion network to the auxiliary network; combine the first set of activations from the first layer of the diffusion network to a first set of activations from a first layer of the auxiliary network to generate first combined activations; output a second set of activations from a second layer of a diffusion network to the auxiliary network; combine the second set of activations from the second layer of the diffusion network to the first combined activations to generate second combined activations; and process, at a second layer of the auxiliary network, the second combined activations to generate auxiliary network output activations used for the training process or the inference process of the diffusion network.

Aspect 35. A non-transitory computer-readable medium having stored thereon instructions that, when executed by one or more processors, cause the one or more processors to perform operations according to any of Aspects 15 to 28.

Aspect 36. An apparatus for generating virtual content in a distributed system, the apparatus including one or more means for performing operations according to any of Aspects 15 to 28.

Aspect 37. An apparatus to providing generative modeling based on input data, comprising: one or more memories configured to store the input data; and one or more processors coupled to the one or more memories and configured to: apply an auxiliary network to a diffusion network to a portion of a training process or an inference process of the diffusion network; and when the auxiliary network is applied: output, based on the input data, a first set of activations from a first layer of the diffusion network to the auxiliary network; combine the first set of activations from the first layer of the diffusion network to a first set of activations from a first layer of the auxiliary network to generate first combined activations; output a second set of activations from a second layer of a diffusion network to the auxiliary network; combine the second set of activations from the second layer of the diffusion network to the first combined activations to generate second combined activations; and process, at a second layer of the auxiliary network, the second combined activations to generate auxiliary network output activations used for the training process or the inference process of the diffusion network.

Aspect 38. A method of providing generative modeling based on input data, the method comprising: applying an auxiliary network to a diffusion network to a portion of a training process or an inference process of the diffusion network; and when the auxiliary network is applied: outputting, based on the input data, a first set of activations from a first layer of the diffusion network to the auxiliary network; combining the first set of activations from the first layer of the diffusion network to a first set of activations from a first layer of the auxiliary network to generate first combined activations; outputting a second set of activations from a second layer of a diffusion network to the auxiliary network; combining the second set of activations from the second layer of the diffusion network to the first combined activations to generate second combined activations; and processing, at a second layer of the auxiliary network, the second combined activations to generate auxiliary network output activations used for the training process or the inference process of the diffusion network.

Aspect 39. An apparatus to provide a generative model based on input data, the apparatus comprising: means for applying an auxiliary network to a diffusion network to a portion of a training process or an inference process of the diffusion network; and means for, when the auxiliary network is applied: outputting, based on the input data, a first set of activations from a first layer of the diffusion network to the auxiliary network; combining the first set of activations from the first layer of the diffusion network to a first set of activations from a first layer of the auxiliary network to generate first combined activations; outputting a second set of activations from a second layer of a diffusion network to the auxiliary network; combining the second set of activations from the second layer of the diffusion network to the first combined activations to generate second combined activations; and processing, at a second layer of the auxiliary network, the second combined activations to generate auxiliary network output activations used for the training process or the inference process of the diffusion network.

Aspect 40. A non-transitory computer-readable medium having stored thereon instructions that, when executed by one or more processors, cause the one or more processors to: apply an auxiliary network to a diffusion network to a portion of a training process or an inference process of the diffusion network; and when the auxiliary network is applied: output, based on input data, a first set of activations from a first layer of the diffusion network to the auxiliary network; combine the first set of activations from the first layer of the diffusion network to a first set of activations from a first layer of the auxiliary network to generate first combined activations; output a second set of activations from a second layer of a diffusion network to the auxiliary network; combine the second set of activations from the second layer of the diffusion network to the first combined activations to generate second combined activations; and process, at a second layer of the auxiliary network, the second combined activations to generate auxiliary network output activations used for the training process or the inference process of the diffusion network.

Aspect 41. An apparatus to provide generative modeling, the apparatus comprising: one or more memories configured to store input data; and a plurality of processors coupled to the one or more memories and configured to: output, based on the input data, a first set of activations from a first layer of a diffusion network operating on a first type of processor of the plurality of processors to an auxiliary network operating on a second type of processor of the plurality of processors; combine the first set of activations from the first layer of the diffusion network to a first set of activations from a first layer of the auxiliary network to generate first combined activations; output a second set of activations from a second layer of a diffusion network to the auxiliary network; combine the second set of activations from the second layer of the diffusion network to the first combined activations to generate second combined activations; process, at a second layer of the auxiliary network, the second combined activations to generate auxiliary network output activations; and apply the auxiliary network output activations to the diffusion network.

Aspect 42. The apparatus of Aspect 41, wherein the first type processor comprises one of a central processing unit, a graphics processing unit, a neural processing unit or a digital signal processor and wherein the second type of processor differs from the first type of processor and comprises one of the central processing unit, the graphics processing unit, the neural processing unit or the digital signal processor.

Aspect 43. A method of generative modeling, the method comprising: outputting, based on input data, a first set of activations from a first layer of a diffusion network to an auxiliary network, wherein the diffusion network operates on a first type of processor of a plurality of processors and the auxiliary network operates on a second type of processor of the plurality of processors; combining the first set of activations from the first layer of the diffusion network to a first set of activations from a first layer of the auxiliary network to generate first combined activations; outputting a second set of activations from a second layer of a diffusion network to the auxiliary network; combining the second set of activations from the second layer of the diffusion network to the first combined activations to generate second combined activations; processing, at a second layer of the auxiliary network, the second combined activations to generate auxiliary network output activations; and applying the auxiliary network output activations to the diffusion network.

Aspect 44. The apparatus of Aspect 43, wherein the first type processor comprises one of a central processing unit, a graphics processing unit, a neural processing unit or a digital signal processor and wherein the second type of processor differs from the first type of processor and comprises one of the central processing unit, the graphics processing unit, the neural processing unit or the digital signal processor.

What is claimed is:

1. An apparatus to provide generative modeling, the apparatus comprising:
one or more memories configured to store input data; and
one or more processors coupled to the one or more memories and configured to:
output, based on the input data, a first set of activations from a first layer of a diffusion network to an auxiliary network;
combine the first set of activations from the first layer of the diffusion network to a first set of activations from a first layer of the auxiliary network to generate first combined activations;
output a second set of activations from a second layer of a diffusion network to the auxiliary network;
combine the second set of activations from the second layer of the diffusion network to the first combined activations to generate second combined activations;
process, at a second layer of the auxiliary network, the second combined activations to generate auxiliary network output activations; and
apply the auxiliary network output activations to the diffusion network.

2. The apparatus of claim 1, wherein the first layer of the diffusion network comprises one of a first three layers of the diffusion network and wherein the second layer of the diffusion network comprises one of a last three layers of the diffusion network.

3. The apparatus of claim 1, wherein the one or more processors are configured to:
train the diffusion network using the auxiliary network output activations.

4. The apparatus of claim 1, wherein the one or more processors are configured to:
combine the auxiliary network output activations to diffusion network output activations to generate combined output activations.

5. The apparatus of claim 4, wherein the one or more processors are configured to:
train the diffusion network using the combined output activations.

6. The apparatus of claim 4, wherein the one or more processors are configured to:
perform inference using the diffusion network based on the combined output activations.

7. The apparatus of claim 1, wherein the diffusion network comprises a step-distillation diffusion network.

8. The apparatus of claim 1, wherein the auxiliary network is optionally used for processing high frequency components associated with data.

9. The apparatus of claim 1, wherein, when training the diffusion network, the auxiliary network is used for a portion of a training process.

10. The apparatus of claim 9, wherein, when training the diffusion network, the auxiliary network is used for a first portion of the training process and thereafter the auxiliary network is dropped out of the training process.

11. The apparatus of claim 9, wherein the portion of the training process in which the auxiliary network is used is at least one of: chosen randomly, chosen based on a characteristic of data being processed, chosen based on a desired quality, chosen based on an amount of processing needed to process the data, or chosen based on a layer associated with one of more of the diffusion network and the auxiliary network.

12. The apparatus of claim 1, wherein, when training the diffusion network, the first layer of the auxiliary network and the second layer of the auxiliary network are initialized either randomly or using weights from the first layer of the diffusion network and the second layer of the diffusion network.

13. The apparatus of claim 1, wherein the auxiliary network is not used during inference of the diffusion network.

14. The apparatus of claim 1, wherein the auxiliary network comprises a semantic-aware auxiliary network that is used for a portion of a training process or inference process.

15. A method of generative modeling, the method comprising:
outputting, based on input data, a first set of activations from a first layer of a diffusion network to an auxiliary network;
combining the first set of activations from the first layer of the diffusion network to a first set of activations from a first layer of the auxiliary network to generate first combined activations;
outputting a second set of activations from a second layer of a diffusion network to the auxiliary network;
combining the second set of activations from the second layer of the diffusion network to the first combined activations to generate second combined activations;
processing, at a second layer of the auxiliary network, the second combined activations to generate auxiliary network output activations; and
applying the auxiliary network output activations to the diffusion network.

16. The method of claim 15, wherein the first layer of the diffusion network comprises one of a first three layers of the diffusion network and wherein the second layer of the diffusion network comprises one of a last three layers of the diffusion network.

17. The method of claim 15, further comprising:
training the diffusion network using the auxiliary network output activations.

18. The method of claim 15, further comprising:
combining the auxiliary network output activations to diffusion network output activations to generate combined output activations.

19. The method of claim 18, further comprising:
training the diffusion network using the combined output activations.

20. The method of claim 18, further comprising:
performing inference using the diffusion network based on the combined output activations.
